(19) United States
(12) Patent Application Publication
(10) Pub. No.: US 2026/0188923 A1
(43) Pub. Date: Jul. 2, 2026

(54) TERMINAL BLOCK

(71) Applicant: Yazaki Corporation, Tokyo (JP)

(72) Inventor: Takumi MIZOBE, Shizuoka (JP)

(73) Assignee: Yazaki Corporation, Tokyo (JP)

(21) Appl. No.: 19/430,874

(22) Filed: Dec. 23, 2025

(30) Foreign Application Priority Data
Dec. 26, 2024 (JP) 2024-230110

(51) Int. Cl. H01R 9/24; H01R 4/30; H01R 9/18

(52) U.S. Cl. CPC H01R 9/24; H01R 4/305; H01R 9/18

(57) ABSTRACT

A terminal block is configured to include a bus bar connected to an external terminal (connection counterpart member), a housing provided with an insertion space through which the bus bar is inserted, a packing that seals an annular space between the bus bar and an inner surface of the insertion space, and a front holder configured to include a first holding portion that holds the packing and a second holding portion that holds a nut of a fastening member that fastens the bus bar and the external terminal, the front holder being assembled to the housing.

### CROSS-REFERENCE TO RELATED APPLICATION(S)

The present application claims priority to and incorporates by reference the entire contents of Japanese Patent Application No. 2024-230110 filed in Japan on Dec. 26, 2024.

### BACKGROUND OF THE INVENTION

### 1. Field of the Invention

The present invention relates to a terminal block.

### 2. Description of the Related Art

As a technique related to a conventional terminal block, for example, Japanese Patent Application Laid-open No. JP 2017-224 563 A discloses a terminal block including a bus bar connected to a connection counterpart member, a housing provided with an insertion space through which the bus bar is inserted, and a nut holder holding a nut of a fastening member for fastening the bus bar and the connection counterpart member.

Incidentally, in this type of terminal block, for example, there is a case where a packing holder that holds a packing that seals an annular space between the bus bar and the inner surface of the insertion space is provided separately from the nut holder, and in this case, there is a possibility that the number of parts increases and the assemblability with respect to the housing deteriorates.

### SUMMARY OF THE INVENTION

The present invention has been made in view of the above circumstances, and an object thereof is to provide a terminal block capable of improving assemblability to a housing.

In order to achieve the above mentioned object, a terminal block according to one aspect of the present invention includes a bus bar connected to a connection counterpart member; a housing provided with an insertion space through which the bus bar is inserted; a packing that seals an annular space between the bus bar and an inner surface of the insertion space; and a front holder configured to include a first holding portion that holds the packing and a second holding portion that holds a nut of a fastening member that fastens the bus bar and the connection counterpart member, the front holder being assembled to the housing.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exemplary perspective view of a terminal block according to an embodiment;

FIG. 2 is an exemplary exploded perspective view of the terminal block according to the embodiment;

FIG. 3 is an exemplary perspective view of a front holder of the terminal block according to the embodiment; and

FIG. 4 is an exemplary cross-sectional view of the terminal block according to the embodiment.

### DETAILED DESCRIPTION OF THE PREFERRED EMBODIMENTS

Hereinafter, an embodiment according to the present invention will be described in detail with reference to the drawings. Note that the invention is not limited by the following embodiments. In addition, constituent elements in the following embodiments include those that can be easily replaced by those skilled in the art or those that are substantially the same. In the present specification, ordinal numbers are used only to distinguish components, members, parts, positions, directions, and the like, and do not indicate order or priority.

### Embodiment

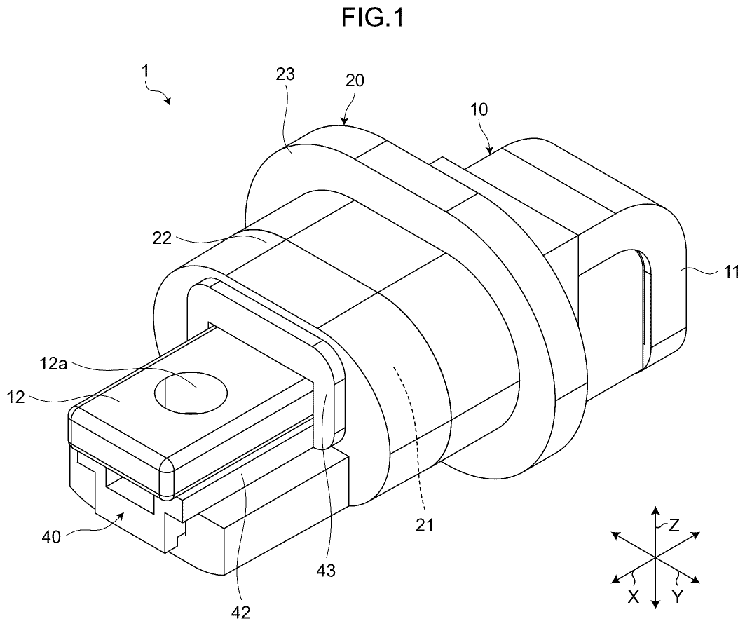

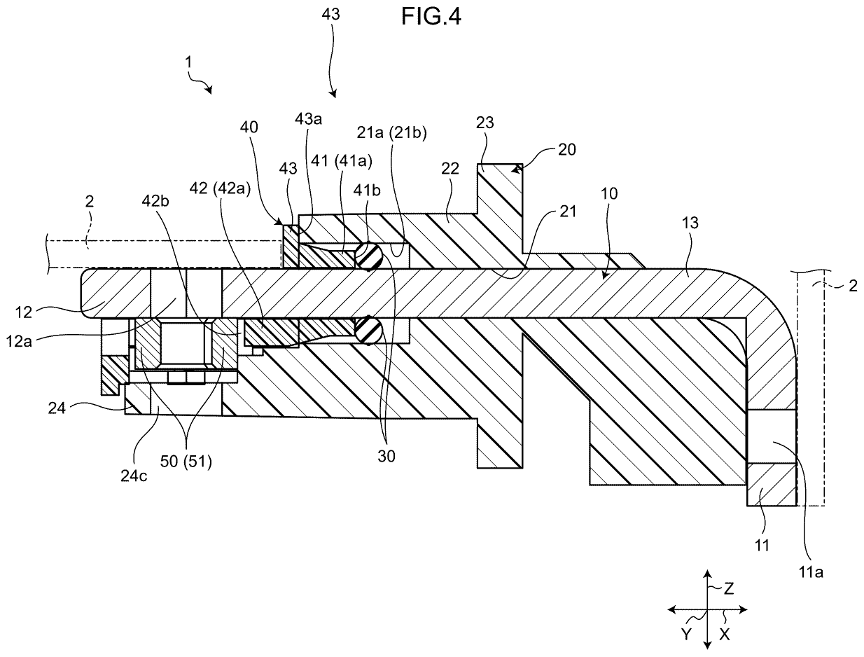

FIG. 1 is a perspective view of a terminal block 1 according to an embodiment. The terminal block 1 of the present embodiment illustrated in FIG. 1 is mounted on a vehicle such as an electric car or a hybrid car, for example, and relays electrical connection between a first device and a second device (not illustrated). The terminal block 1 of the present embodiment is configured to include a bus bar 10, and an external terminal 2 (see FIG. 4) of the first device is electrically connected to a first connection portion 11 provided at one end of the bus bar 10. In the terminal block 1 of the present embodiment, an external terminal 2 of the second device is electrically connected to a second connection portion 12 provided at the other end of the bus bar 10. In the present embodiment, the external terminal 2 of the first device or the second device is an example of a connection counterpart member. The first device is, for example, one of a motor and an inverter, and the second device is, for example, the other of the motor and the inverter. Note that the terminal block 1 is not limited to this example, and may be used for, for example, relaying between the first device or the second device and a wiring member, relaying between the wiring member and the wiring member, and the like.

In the following description, among a first direction, a second direction, and a third direction intersecting each other, the first direction is referred to as an “axial direction X”, the second direction is referred to as a “width direction Y”, and the third direction is referred to as a “height direction Z”. Here, the axial direction X, the width direction Y, and the height direction Z are substantially orthogonal to each other. Typically, the axial direction X corresponds to an extending direction of the bus bar 10, an insertion direction of the bus bar 10 with respect to a housing 20 (insertion space 21), a fastening direction of the first connection portion 11 of the bus bar 10 and the external terminal 2, a depth direction (front-rear direction) of the terminal block 1, and the like. The width direction Y typically corresponds to the width direction of the bus bar 10, the width direction (left-right direction) of the terminal block 1, and the like. The height direction Z typically corresponds to a height direction (plate thickness direction) of the bus bar 10, a fastening direction of the second connection portion 12 of the bus bar 10 and the external terminal 2, a height direction (vertical direction) of the terminal block 1, and the like. In addition, each direction used in the following description will be described as a direction in a state where the terminal block 1 is mounted on a vehicle unless otherwise specified.

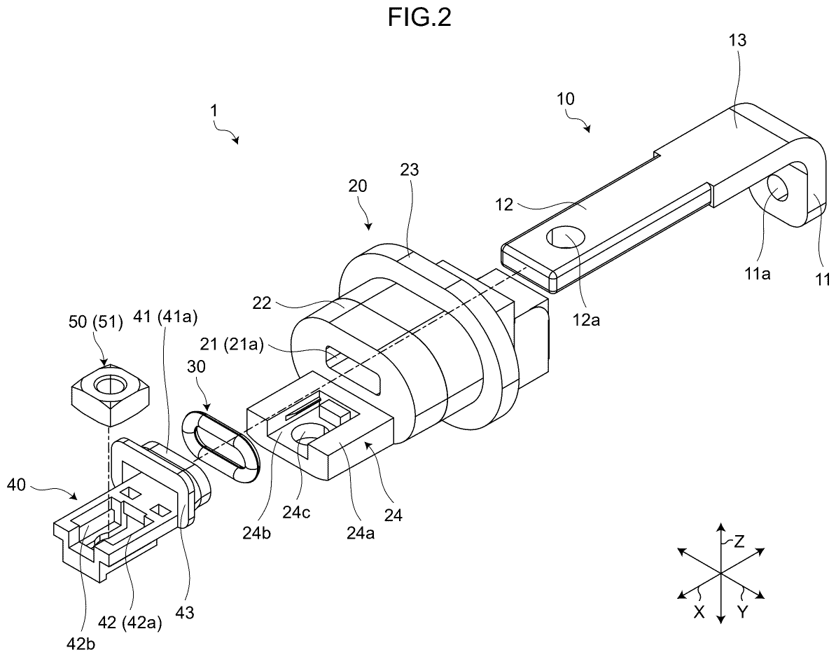

FIG. 2 is an exploded perspective view of the terminal block 1. As illustrated in FIG. 2, the terminal block 1 is configured to include, for example, a bus bar 10, a housing 20, a packing 30, a front holder 40, and a fastening member 50. The bus bar 10 is a terminal fitting made of a conductive metal material, and is electrically connected to the external terminal 2 described above. In the present embodiment, one bus bar 10 is provided on the terminal block 1. Note that the number of the bus bars 10 is not limited to this example, and for example, a plurality of bus bars 10 may be provided side by side along the width direction Y.

The bus bar 10 is configured to include, for example, a first connection portion 11 provided at one end in the axial direction X, a second connection portion 12 provided at the other end in the axial direction X, and an intermediate portion 13 provided between the first connection portion 11 and the second connection portion 12. The first connection portion 11, the second connection portion 12, and the intermediate portion 13 are integrally formed of a conductive metal material. That is, the bus bar 10 is formed such that each portion is three-dimensionally integrated into a crank shape by performing various processing such as bending on one sheet of metal in accordance with the shape corresponding to each of the first connection portion 11, the second connection portion 12, and the intermediate portion 13.

The first connection portion 11 is a portion electrically and mechanically connected to the external terminal 2 of the first device described above. The first connection portion 11 extends, for example, along the height direction Z. The first connection portion 11 is provided with an attachment hole 11a to which a bolt or the like of the fastening member 50 for fastening the bus bar 10 and the external terminal 2 is attached. The attachment hole 11a is a through hole penetrating the first connection portion 11 along the axial direction X, and is configured as, for example, a round hole having substantially the same diameter as the shaft portion of the bolt.

The second connection portion 12 is a portion electrically and mechanically connected to the external terminal 2 of the second device described above. For example, the second connection portion 12 extends along the axial direction X and is positioned to be shifted toward the other end side in the axial direction X with respect to the first connection portion 11. The second connection portion 12 is provided with an attachment hole 12a to which a bolt or the like of the fastening member 50 for fastening the bus bar 10 and the external terminal 2 is attached. The attachment hole 12a is a through hole penetrating the second connection portion 12 along the height direction Z, and is configured as, for example, a round hole having a larger diameter than the shaft portion of the bolt. As a result, the attachment hole 12a can absorb positional deviation of the fastening member 50 along the axial direction X with respect to a nut 51 to be described later.

The intermediate portion 13 is a portion connected between the first connection portion 11 and the second connection portion 12. The intermediate portion 13 includes, for example, a bent portion interposed between the first connection portion 11 and the second connection portion 12. The bent portion is bent at an angle of approximately 90° with respect to the first connection portion 11 and the second connection portion 12, for example. In the present embodiment, the lateral width of the intermediate portion 13 along the width direction Y is substantially the same as the lateral width of the first connection portion 11 along the width direction Y, and is configured to be slightly larger than the lateral width of the second connection portion 12 along the width direction Y.

The housing 20 holds the bus bar 10, the front holder 40, and the like, and is formed of an insulating synthetic resin material or the like. The housing 20 is configured to include, for example, a housing body 22, a flange portion 23 protruding outward in the radial direction (the width direction Y and the height direction Z) from the housing body 22, and a protrusion portion 24 protruding toward the other end side in the axial direction X from the housing body 22. In the housing 20, the housing body 22, the flange portion 23, and the protrusion portion 24 are integrally formed. The flange portion 23 is formed in, for example, a substantially elliptical annular shape along the outer peripheral surface of the housing body 22.

The housing body 22 is provided with an insertion space 21 through which a part of the second connection portion 12 and the intermediate portion 13 of the bus bar 10 is inserted along the axial direction X. The insertion space 21 is, for example, an opening (through hole) penetrating the housing body 22 along the axial direction X. In the present embodiment, the bus bar 10 is assembled to the housing 20 by being inserted into the insertion space 21 along the axial direction X, for example. The terminal block 1 is not limited to this example, and for example, the bus bar 10 and the housing 20 may be integrally molded by insert-molding or the like.

The protrusion portion 24 is configured to include, for example, a protrusion body 24a, a groove portion 24b, and an insertion hole 24c. The protrusion body 24a is provided on the other end surface of the housing body 22 in the axial direction X and protrudes from the other end surface along the axial direction X. The protrusion body 24a is formed in, for example, a substantially rectangular flat plate shape extending along a direction (XY plane) intersecting the height direction Z. The protrusion body 24a is positioned to be shifted toward the other end side (lower side) in the height direction Z with respect to the insertion space 21 on the other end surface of the housing body 22.

The groove portion 24b is, for example, recessed from the upper surface of the protrusion body 24a toward the other end side (lower side) in the height direction Z and opened toward the one end side (upper side) in the height direction Z. The groove portion 24b is engaged with an outer surface of a second holding portion 42 of the front holder 40 to be described later, and holds the second holding portion 42. An insertion hole 24c through which a bolt of the fastening member 50 is inserted is provided at the bottom of the groove portion 24b. The insertion hole 24c is a through hole penetrating the protrusion body 24a along the height direction Z, and is configured as, for example, a round hole having a larger diameter than the shaft portion of the bolt.

The packing 30 suppresses entry of foreign matter such as moisture into the housing 20. The packing 30 is formed of, for example, an elastically deformable member such as rubber or resin. For example, the packing 30 is formed in a substantially elliptical annular shape along the outer surface of the second connection portion 12 of the bus bar 10, and is inserted into the insertion space 21 described above. The packing 30 is configured to come into close contact with the outer surface of the second connection portion 12 and an inner surface 21a (see FIG. 4) of the insertion space 21 by elastic deformation, and seal the annular space between the outer surface of the second connection portion 12 and the inner surface 21a of the insertion space 21. The packing 30 is also referred to as an O-ring or the like.

For example, a pair of fastening members 50 is provided corresponding to the first connection portion 11 and the second connection portion 12 of the bus bar 10, and fastens the external terminal 2 of the first device and the first connection portion 11, and fastens the external terminal 2 of the second device and the second connection portion 12. Each of the pair of fastening members 50 is configured to include a bolt (not illustrated) and a nut 51 provided with a female screw portion meshing with a male screw portion of the bolt. In the present embodiment, the nut 51 of the fastening member 50 on the second connection portion 12 side is attached and fixed to the housing 20 in a state of being held by the second holding portion 42 of the front holder 40 described later, and is aligned with the attachment hole 12a in the height direction Z as the second connection portion 12 is inserted into the insertion space 21. In the fastening member 50 on the second connection portion 12 side, the male screw portion of the bolt and the female screw portion of the nut 51 are fastened in a state where the second connection portion 12 and the external terminal 2 are sandwiched between the head portion of the bolt and the nut 51.

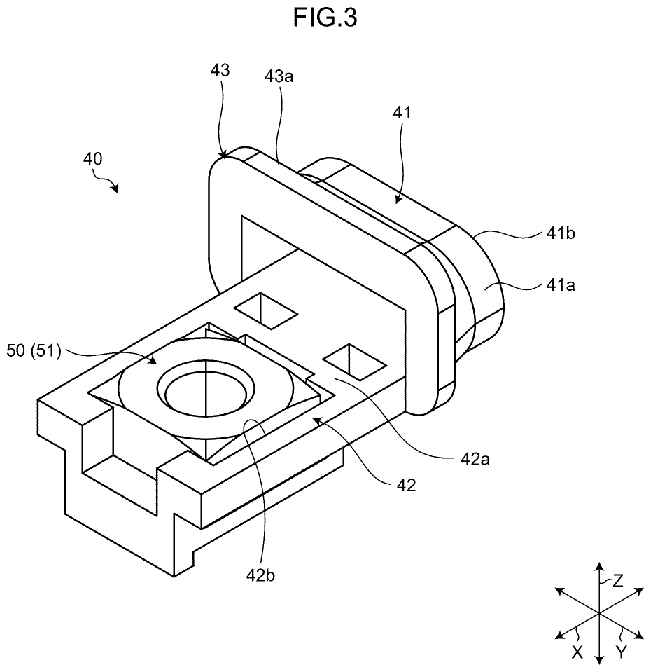

FIG. 3 is a perspective view of the front holder 40 of the terminal block 1, and FIG. 4 is a cross-sectional view of the terminal block 1. As illustrated in FIGS. 3 and 4, the front holder 40 holds the packing 30, the nut 51 of the fastening member 50, and the like described above, and is formed of an insulating synthetic resin material or the like. The front holder 40 is configured to include, for example, a first holding portion 41 that holds the packing 30, a second holding portion 42 that holds the nut 51, and a flange portion 43. In the front holder 40, the first holding portion 41, the second holding portion 42, and the flange portion 43 are integrally formed. That is, in the front holder 40, the first holding portion 41, the second holding portion 42, and the flange portion 43 are configured by a single part.

The first holding portion 41 is provided at one end of the front holder 40 in the axial direction X. The first holding portion 41 is configured to include, for example, a cylindrical portion 41a to be inserted into the insertion space 21 of the housing 20. The cylindrical portion 41a is formed in, for example, a substantially elliptical cylindrical shape along the inner surface 21a of the insertion space 21 and the outer surface of the second connection portion 12 of the bus bar 10. The second connection portion 12 is inserted into the cylindrical portion 41a along the axial direction X. In the present embodiment, for example, the packing 30 is held by a distal end surface 41b on one end side in the axial direction X of the cylindrical portion 41a coming into contact with the packing 30 inserted in advance into the insertion space 21. That is, the first holding portion 41 holds (supports) the packing 30 in the axial direction X by the distal end surface 41b of the cylindrical portion 41a.

In the present embodiment, the insertion space 21 is configured to include, for example, a small diameter portion and a large diameter portion 21b having an opening width larger than that of the small diameter portion. The small diameter portion is provided on one end side in the axial direction X of the insertion space 21, and only a part of the second connection portion 12 and the intermediate portion 13 of the bus bar 10 are inserted. On the other hand, the large diameter portion 21b is provided on the other end side in the axial direction X of the insertion space 21, and the second connection portion 12 of the bus bar 10, the packing 30, and the first holding portion 41 (cylindrical portion 41a) of the front holder 40 are inserted into the large diameter portion.

In the present embodiment, for example, the first holding portion 41 (cylindrical portion 41a) is press-fitted into the large diameter portion 21b of the insertion space 21, and the second holding portion 42 is engaged with the groove portion 24b of the protrusion portion 24 described above, whereby the front holder 40 is assembled to the housing 20. In FIG. 4, for convenience, a gap is provided between the outer peripheral surface of the cylindrical portion 41a and the inner surface 21a of the large diameter portion 21b, but actually, the inner surface 21a of the large diameter portion 21b is formed in a shape along the outer peripheral surface (tapered surface) of the cylindrical portion 41a, and the inner surface 21a of the large diameter portion 21b and the outer peripheral surface of the cylindrical portion 41a are assembled in close contact with each other.

The second holding portion 42 is provided at the other end of the front holder 40 in the axial direction X. The second holding portion 42 is configured to include, for example, a base portion 42a that supports the second connection portion 12 of the bus bar 10 and a recess portion 42b that holds the nut 51. The base portion 42a is provided at the other end of the first holding portion 41 (cylindrical portion 41a) in the axial direction X and protrudes from the other end along the axial direction X. For example, the base portion 42a is positioned to be shifted toward the other end side (lower side) in the height direction Z with respect to the insertion hole of the first holding portion 41 (cylindrical portion 41a). The base portion 42a has, for example, a flat upper surface, and supports the second connection portion 12 by the upper surface.

The recess portion 42b is, for example, recessed from the upper surface of the base portion 42a toward the other end side (lower side) in the height direction Z and opened toward one end side (upper side) in the height direction Z. The recess portion 42b is engaged with the nut 51 and holds the nut 51. For example, the recess portion 42b is formed in a rectangular shape along the outer peripheral surface of the nut 51 when viewed from the height direction Z (see FIGS. 2 and 3). Therefore, in the present embodiment, the rotation of the nut 51 with respect to the recess portion 42b can be suppressed by the abutment between the side surface of the recess portion 42b and the outer peripheral surface of the nut 51. In the present embodiment, the nut 51 is press-fitted and fixed to the recess portion 42b.

The flange portion 43 is provided between the first holding portion 41 and the second holding portion 42. The flange portion 43 protrudes radially outward from the other end of the first holding portion 41 (cylindrical portion 41a) in the axial direction X. The flange portion 43 has one end surface 43a (see FIG. 4) facing the peripheral edge portion of the insertion space 21 on the other end surface of the housing body 22 in the axial direction X. In the present embodiment, for example, the abutment between the one end surface 43a and the other end surface of the housing body 22 restricts the movement of the front holder 40 toward the one end side in the axial direction X with respect to the housing 20, and eventually, the first holding portion 41 and the packing 30 are pushed into a predetermined position of the insertion space 21 (large diameter portion 21b).

As described above, in the terminal block 1 of the present embodiment, the front holder 40 is configured to include the first holding portion 41 which holds the packing 30 and the second holding portion 42 which holds the nut 51 of the fastening member 50 which fastens the bus bar 10 and the external terminal 2 (connection counterpart member), and is assembled to the housing 20. With this configuration, in the terminal block 1, for example, the number of components assembled to the housing 20 by the first holding portion 41 and the second holding portion 42 of the front holder 40 can be reduced. As a result, the terminal block 1 can be improved in assemblability with respect to the housing 20.

Further, in the terminal block 1 of the present embodiment, the first holding portion 41 is configured to include the cylindrical portion 41a to be inserted into the insertion space 21, and holds the packing 30 by the distal end surface 41b of the cylindrical portion 41a. With this configuration, in the terminal block 1, for example, the packing 30 can be held along the axial direction X (the insertion direction of the cylindrical portion 41a with respect to the insertion space 21) by the distal end surface 41b of the cylindrical portion 41a, and furthermore, the movement (pull-out) of the packing 30 with respect to the first holding portion 41 along the axial direction X can be suppressed.

In the terminal block 1 of the present embodiment, the second holding portion 42 is configured to include a recess portion 42b for holding the nut 51, and the nut 51 is press-fitted and fixed to the recess portion 42b. With this configuration, in the terminal block 1, for example, the nut 51 can be more firmly held by the recess portion 42b, and furthermore, the positional deviation (pull-out, rotation, etc.) of the nut 51 with respect to the second holding portion 42 can be suppressed.

In the present embodiment, the case where the packing 30 is held by the distal end surface 41b of the first holding portion 41 (cylindrical portion 41a) in the front holder 40 has been exemplified, but the present invention is not limited to this example. For example, the packing 30 may be held by the outer peripheral surface of the first holding portion 41 (cylindrical portion 41a). In the present embodiment, the case where the front holder 40 is assembled to the housing 20 by press-fitting the first holding portion 41 into the insertion space 21 and engaging the second holding portion 42 with the groove portion 24b of the protrusion portion 24 has been exemplified, but the present invention is not limited to this example, and the front holder 40 may be assembled to the housing 20 by claw engagement or the like, for example. In the present embodiment, the connection counterpart member is the external terminal 2 of the first device or the second device, but the present invention is not limited to this example.

Although the embodiments of the present invention have been exemplified above, the above embodiments are merely examples, and are not intended to limit the scope of the invention. The above-described embodiments can be implemented in various other forms, and various omissions, substitutions, combinations, and changes can be made without departing from the gist of the invention. In addition, specifications (structure, type, direction, form, size, length, width, thickness, height, number, arrangement, position, material, and the like) of each configuration, shape, and the like can be appropriately changed and implemented.

In a terminal block according to the present embodiment, a front holder is configured to include a first holding portion which holds a packing and a second holding portion which holds a nut of a fastening member which fastens a bus bar and a connection counterpart member, and is assembled to a housing. With this configuration, in the terminal block, for example, the number of components assembled to the housing by the first holding portion and the second holding portion of the front holder can be reduced. As a result, the terminal block can improve the assemblability with respect to the housing.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal block comprising:
a bus bar connected to a connection counterpart member;
a housing provided with an insertion space through which the bus bar is inserted;
a packing that seals an annular space between the bus bar and an inner surface of the insertion space; and
a front holder configured to include a first holding portion that holds the packing and a second holding portion that holds a nut of a fastening member that fastens the bus bar and the connection counterpart member, the front holder being assembled to the housing.

2. The terminal block according to claim 1, wherein
the first holding portion is configured to include a cylindrical portion to be inserted into the insertion space, and holds the packing by a distal end surface of the cylindrical portion.

3. The terminal block according to claim 1, wherein
the second holding portion is configured to include a recess portion that holds the nut, and the nut is press-fitted and fixed to the recess portion.

4. The terminal block according to claim 2, wherein
the second holding portion is configured to include a recess portion that holds the nut, and the nut is press-fitted and fixed to the recess portion.
